(19) United States
(12) Patent Application Publication
(10) Pub. No.: US 2011/0010623 A1
(43) Pub. Date: Jan. 13, 2011

(54) Synchronizing Audio-Visual Data With Event Data

(76) Inventors: Paul J. Vanslette, Upton, MA (US); Alpin C. Chisholm, North Attleboro, MA (US); Stephen E. Rubin, Needham, MA (US)

Correspondence Address: FISH & RICHARDSON P.C. (BO), P.O. BOX 1022, MINNEAPOLIS, MN, 55440-1022, US

(21) Appl. No.: 12/500,927

(22) Filed: Jul. 10, 2009

(51) Int. Cl. G06F 3/01

(52) U.S. Cl. 715/704; 715/716

(57) ABSTRACT

In general, a user interface portrays both at least a portion of a time history of a sequence of events that has occurred, and at least a portion of a time track of audio-visual material associated with the time history of the sequence of events. An indication of one of the events or of a time is received, and the portrayal of either the time history or the time track is caused to be adjusted to be in synchrony with the other of the time history or the time track with respect to which the indication has been received.

### BACKGROUND

This description relates to synchronizing audio-visual data with event data. In environments such as factories, sensor data is often stored in a data archive that records the history of the sensor states. Video clips of equipment on the factory floor may also be archived. A user can link the playback of video data and sensor data by storing the actual video, or a reference to the video file, and the start and stop points of the video of interest, as an object within an application.

### SUMMARY

In general, in an aspect, a user interface portrays both (a) at least a portion of a time history of a sequence of events that has occurred, and (b) at least a portion of a time track of audio-visual material associated with the time history of the sequence of events. An indication is received of one of the events or of a time. A portrayal of either the time history or the time track is adjusted to be in synchrony with the other of the time history or the time track.

Implementations may include one or more of the following features. The audio-visual material includes at least one of video material and audio material. The audio-visual material and the time history are stored separately. The audio-visual material and the time history of the sequence of events are stored separately while the portrayal is caused to be in synchrony. A user is enabled to select a type of the events and the sequence of which is portrayed graphically. The user is enabled to navigate within the interface with respect to time. The user is enabled to navigate within the interface with respect to information related to the sequence of events. An audio-visual capture device is associated with a context in which the sequence of events occurs. The audio-visual capture device includes a camera. Context information is compared with configurable parameters. A record is generated that contains an association between the audio-visual capture device and the context in which the sequence of events occurs. The time history is stored in a first file that includes one or more event timestamps representative of times of occurrence of the events, and the audio-visual material is stored in a second file that includes one or more audio-visual timestamps representative of points in time within the audio-visual material. The user interface displays a first timeline associated with the audio-visual material and a second timeline associated with the time history, the first and second timelines being based in part on the event timestamps and the audio-visual timestamps. The navigating to a specific point in time within either the first timeline or the second timeline causes a navigation to the specific point in time within the other of the first timeline or the second timeline.

In general, in an aspect, a user navigates along (a) a graphically displayed time history of a sequence of events that has occurred or (b) a simultaneously graphically displayed time track of audio-visual material associated with the time history of the sequence of events. As the user navigates, the display of the other of the time history or the time track is automatically synchronized.

In general, in an aspect, audio-visual material is received and stored in a first storage location, a time history of a sequence of events is stored in a second storage location, and an application accesses the audio-visual material and the time history to simultaneously display a graphically displayed time history of a sequence of events that has occurred and a time track of audio-visual material associated with the time history of the sequence of events.

In general, in an aspect, a user interface: (a) portrays to a user audio-visual material for a frame of view being monitored, and (b) displays navigation features to the user that are based on data about occurrences in the frame of view. The navigation features are based on existing data that has been accumulated by a system that controls at least some of the occurrences in the frame of view. The navigation features enable the user to identify one of the occurrences as an occurrence of interest and to have the user interface then automatically portray a portion of the audio-visual material that relates to that occurrence of interest.

Implementations may include one or more of the following features. The data about occurrences associated with the field of view includes a trend chart. The data about occurrences associated with the field of view includes process events or alarms. The data about occurrences associated with the field of view includes data fields of a process control database. The system includes a process control system and the frame of view and the occurrences are associated with a process being controlled.

These and other features and aspects, and combinations of them, may be expressed as methods, apparatus, systems, components, methods of doing business, means or steps for performing functions, and in other ways.

Other advantages and features will become apparent from the following description and from the claims.

### DESCRIPTION

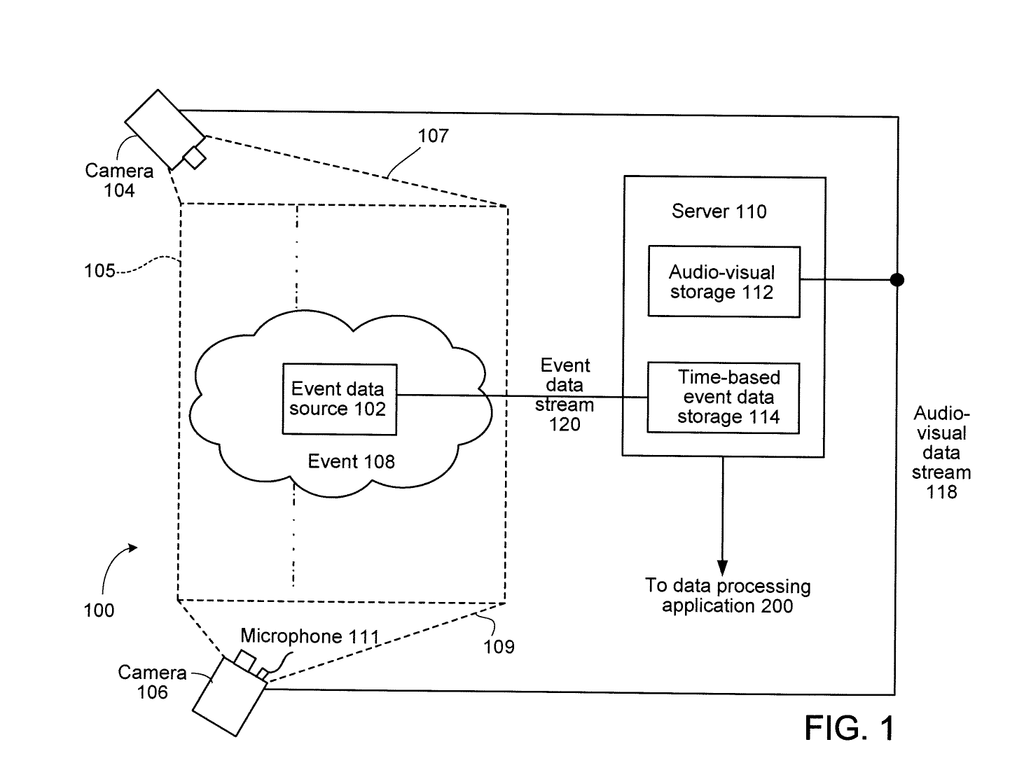

FIGS. 1-5 are block diagrams.

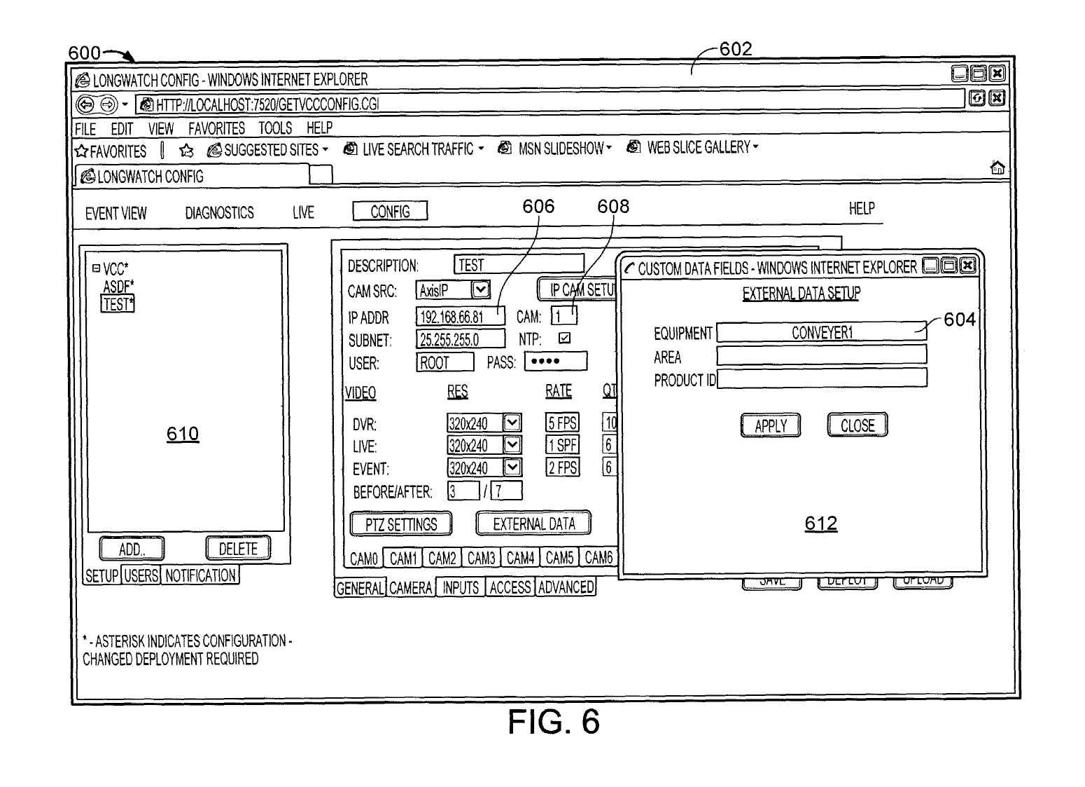

FIGS. 6-8 are screenshots of a user interface.

As shown in FIG. 1, a system 100 monitors events such as adding hops 101 to a wort tank 103 at a brewery. In the example of FIG. 1, the system includes video cameras 104 and 106, however, the system is scalable and can support any number of cameras, from one to many. The cameras can be positioned to record an environment 105 that is within the field of view 107 of camera 104 and within the field of view 109 of camera 106. An exemplary environment could be an area of a factory 107 showing the brewhouse floor 109 described above, containing a number of vessels. One camera might have a field of view 115 for all vessels 111 within the brewhouse, while other cameras might have their fields of view 113 limited to one or two vessels. In some examples, each camera may pan, tilt and zoom to change the field of view. Each camera may also include a microphone 111 to acquire audio data or to trigger an event of interest.

The system 100 also includes an event data source 102, which may include one or more sensors, alarms, or other devices that detect the occurrence of events 108. Each event data source 102 can also associate each event 108 with a time period of occurrence during which an event occurs. For example, the event data source 102 can detect if a hatch 121 is opened on a wort kettle and can associate a time period of occurrence with that event, in other words the period during which the hatch remains open. event data collected by the event data source can be sensor data collected automatically and at specific time periods (e.g. once a second), or can be data associated with text alarm messages, or in other ways. In some examples, when the event data is an alarm message, the time of the event is included within the text string of the message.

In FIG. 1, the cameras 104 and 106 and the event data source 102 are positioned and configured to record events 108 that are associated with the field of view of both cameras, and within the range of the event data source. The cameras record audio-visual data and transmit audio-visual data streams 118 (in this case two streams) to an audio-visual storage element 112 within a server 110 (e.g., a hard drive). The server 110 is shown as a single machine in the example of FIG. 1; however, the functions of the server 110 could be performed by any number of machines and components connected on a network. Similarly, the event data source 102 gathers data related to the occurrence (or non-occurrence) of the event 108. Each event data source 102 transmits an event data stream 120 to an event data storage element 114 within the server 110. Each data stream (e.g., a stream of measurements and status of a sensor) may or may not have an associated time stamp for each event in the stream. In some examples, the status of the event data source may cause a different system component to apply a time stamp to data within the data stream. For example, . . . Each of the audio-visual data streams 118 and the each of the event data streams 120 include data recorded by the cameras 104 and 106 and the event data source 102, respectively. Both the audio-visual data stream 118 and the event data stream 120 can be transmitted over a wireless network, a wired network, or a network that includes both wireless and wired connections. An example of a low bandwidth network that may be suitable for the communications described above is described in U.S. application Ser. No. 11/052,393, which is incorporated here by reference.

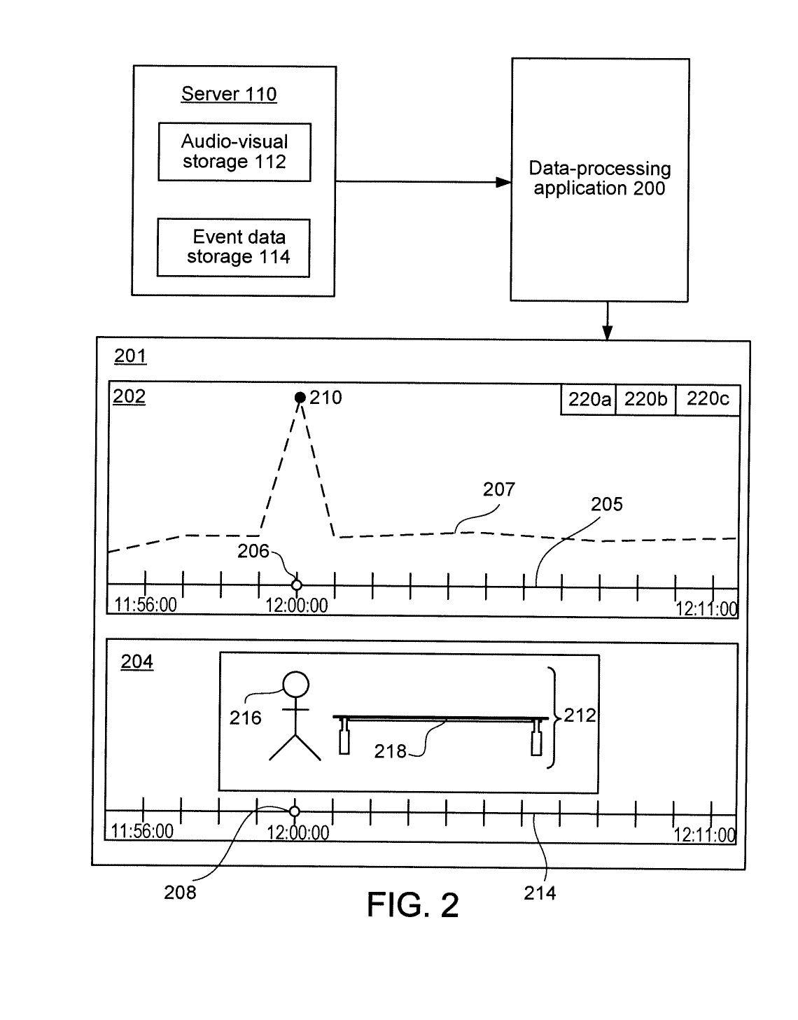

As shown in FIG. 2, the server 110 communicates with a data processing application 200. The data processing application receives data from the server 110 (from both audio-visual storage element 112 and event data storage element 114), processes the data, and generates an output 214 that can be used to drive an interface 201. The interface 201 can be displayed on an electronic display and can be launched within an Internet browsing application. In some examples, the interface can run on specially designed software (for example, when controls, such as ActiveX controls, are added to a user's Human Machine Interface software display). The electronic display could be a dedicated terminal or any number of personal computers with access to the audio-visual data stream 118 and the event data stream 120 (FIG. 1).

Interface 201 includes an event grid 202 and a video window 204. The Event grid 202 can be displayed in a variety of formats such as graphical or textual format. A control, such as an ActiveX control 203, within the interface can connect to the server in order to retrieve the video data and display a video within the interface. The event grid 202 and the video window 204 can have a number of shapes, sizes, aspect ratios, and settings. The video window 204 can also display more than one video clip. For example, the video window 204 can display three video clips that are associated with three different sources of audio-visual data. The interface can be a user interface that is displayed on an electronic display 205. In some examples, the event grid 202 displays information related to an event 108 (FIG. 1) that was collected by the event data source 102 (FIG. 1) and that was stored in the event data storage element 114.

The event grid includes a timeline 205 and a time cursor 206. The time cursor indicates a current time of interest, for example, time 12:00:00. The timeline 205 spans a range of time that begins at 11:56:00 and ends at 12:11:00. A user (or some other process) can change the position of the time cursor 206 on the timeline 205 in order to indicate a new time of interest. Changing the position of the time cursor can also shift the range of time displayed by the event grid. For example, moving the time cursor 206 toward the right end of timeline 205 (e.g., by clicking the time cursor with a mouse and dragging the time cursor across the electronic display) would advance the current time of interest and would shift the range of displayed time to include a different range of times. In some implementations, the time of interest and the displayed range of time could be adjusted separately. Additionally, the scale of the event grid could also be adjusted (e.g., the time period could be adjusted to display event data over a period of hours instead of minutes and seconds).

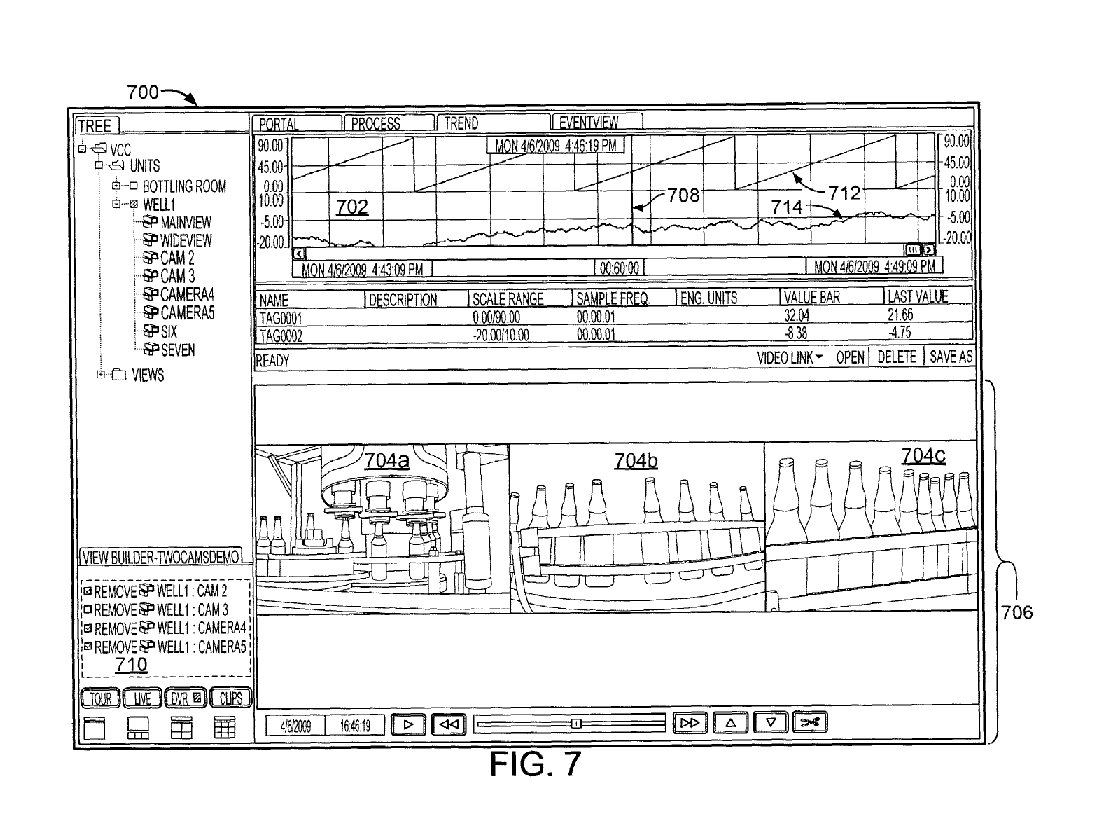

The event grid 202 can display, for example, a trend chart 207 (see also the example of FIG. 7). The trend chart provides a visual representation of the data generated by event data source 102 (FIG. 1). In this example, the trend chart shows that an event 210 has occurred at 12:00:00. Because the time cursor 206 is positioned at 12:00:00, the video window 204 will display audio-visual information 212 (such as a video clip) that shows what is happening over a period of time that includes the time 12:00:00. As a result, in this particular example, the video window will display audio-visual frames the occurrence of the event 210. For example, playing back audio-visual frames associated with an event that has occurred at 12:00:00 can cause the video window to display a video that begins at 12:00:00.

For instance, at time 12:00:00, the trend chart 207 within event grid 202 shows the occurrence of the event 210. At the same time, the video window 204 displays audio-visual information 212 (e.g., a person 216 standing next to a table 218) at 12:00:00. That is, at time 12:00:00, the audio-visual information would be a single frame that was captured at time 12:00:00. The single frame shown at time 12:00:00 could be the first frame of a video played back from that point in time (e.g., the first frame in a sequence of frames that make up a video segment). A second time cursor 208 is positioned at 12:00:00 on a second timeline 214 indicating that the audio-visual data being displayed in video window 204 coincides with the time selected in the event grid 202. In this way, the event data and the audio-visual data are synchronized. A user can select a point (e.g., event 210) on the trend chart 207 to obtain further information about the selected point. Further information related to the selected point can be displayed as numerical information when a user “hovers” a mouse cursor over a point on the trend chart, or when the user selects a point on either the trend chart 207 or the timeline 205.

A user can use traditional tools (such as timelines 205, 214, and time cursors 206, 208) to navigate to different times on either the event grid 202 or the video window 204. In addition to the timelines and time cursors, the interface 201 can also include a navigation and display format controls for user convenience.

The event grid can also contain tabs 220a, 220b, and 220c that are selectable by a user (e.g., by clicking a tab with a pointer using a mouse). Each tab can cause the event grid to display different types of information and behavior. For example, an “Event” tab displays information in a tabular grid format. Each line in the grid may represent an occurrence of an event. The data associated with the event can be organized in columns. For example, one column can represent the time of the event, and another column can represent the name of the event data source that detected or triggered the event. Another column can represent the type of message (event messages may be alarms requiring action by the user, or status messages simply informing the user). If a video clip is associated with the event, then the software prefixes the message line with a graphic icon indicating to the user that video is attached. Clicking on the icon causes the video to appear and play automatically. A camera database may include user-definable attributes (e.g., labels). Upon the detection of an event, an associated event message will be constructed with the contents of these attributes. The message is placed in the database that represents the Event tab(e.g., a relational database). The interface enables messages to be filtered and sorted using this information.

In some examples, the presentation of a “Process” tab is similar to the presentation of the Event tab. In the Process tab, the grid is populated by extracting alarm message data from a separate data collection/alarm management system using Structured Query Language (SQL). Once that data has been collected, the software determines whether there are any strings within the alarm message that match the tracking strings in the camera configuration data. If there are strings within the alarm message that match, the software prefixes the message line with a graphic icon indicating that video is associated. When the user clicks on the icon, the video is displayed. (The mechanism for retrieving the video in this instance is different than the mechanism used for the “Event” tab).

A “portal” tab can display a URL address or HTML file that the user has pre-configured. The behavior and display characteristics of this tab are dependent on the URL/HTML that the user has specified.

In some examples, if the event grid is linked to the video playback system, the video will move forward or backward in time as the user shifts the time cursor 206 along the timeline 205. Similarly, audio-visual data can be linked to event data. For example, when a desired segment of video is found, the system can automatically shift the time of the trend chart to the point in time corresponding with the point in time of the audio-visual data being played. The “linked” or “synchronized” playback of the audio-visual data and the event data allows a user to obtain further information about a time of interest. Furthermore, if a user is viewing video playback in the video window, the user can stop playback of the video at a desired point, and then activate a “link” button (not shown) to automatically display event data corresponding to the point in time selected in the video window.

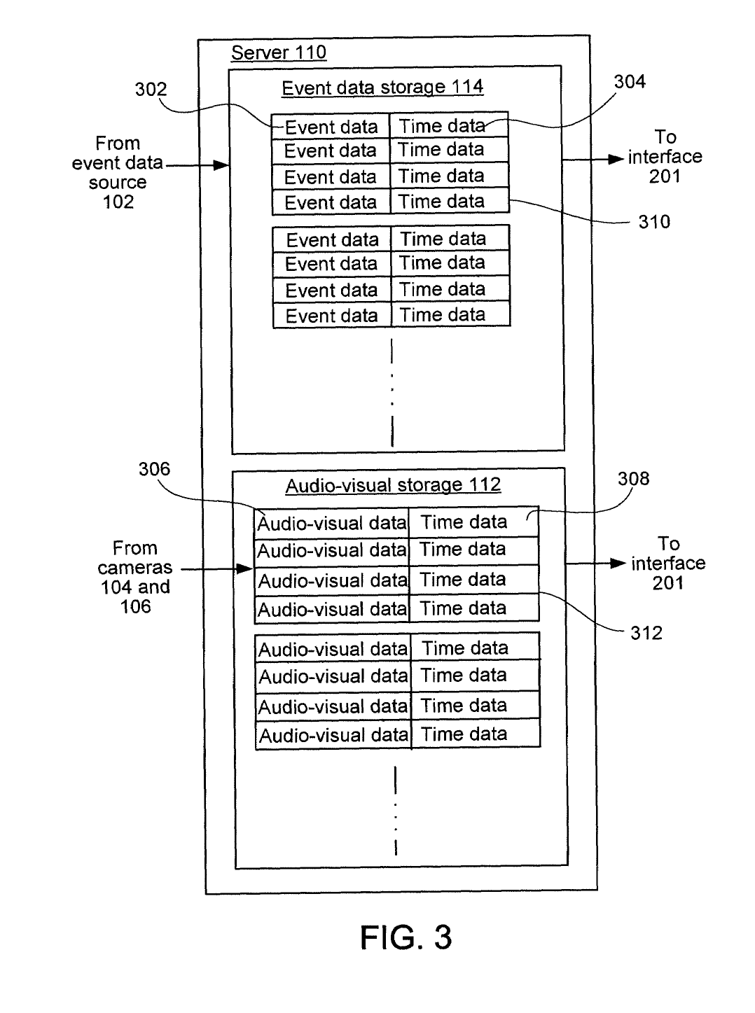

FIG. 3 is a simplified example that shows how the server 110 could store data. The server includes the previously described event data storage 114. The event data storage 114 stores one or more files 310. The file 310 includes both event data 302 and time data 304. The event data 302 indicates the occurrence (or non-occurrence) of an event. Using the previous example, if a worker within the beverage plant opens a hatch to add syrup to a tank, the event data 302 could indicate that a hatch had been opened on the tank. The time data 304 could indicate the relevant time period associated with the corresponding event data (e.g., the time at which the hatch was opened). In some examples, each unit of event data 302 is associated with a corresponding unit of time data 304. The file 310 can hold any amount of event data 302 and time data 304.

The server 110 also includes an audio-visual storage 112. The audio-visual storage 112 receives the audio-visual data stream 118 (FIG. 1) from cameras 104 and 106, and stores audio-visual data 306 in a file 312. The audio-visual data 306 can include both audio and video data. In some examples, video data describes a moving succession of frames with or without audio while audio data describes data representative of captured sound (e.g., sound captured by microphone 113 in FIG. 1). An example of the audio-visual data that could be stored in file 312 is a video clip that shows the bottle falling off of the conveyor belt. The time data 308 can indicate the relevant time period associated with the corresponding audio-visual data (e.g., the period of time spanned by the video clip). The file 312 can hold any amount of audio-visual data 306 and time data 308.

Both the event data storage 114 and the audio-visual data storage 112 provide an output that eventually reaches interface 201. Additional data storage elements and data processing elements can be located between the data sources (e.g., cameras 104 and 106 and event data source 102) and the interface 201. In some examples, if a user navigates to a point in time within the event grid 202, the interface 201 will use a timestamp representing that point in time to locate audio-visual data with a timestamp from the same point in time. That is, the interface can use a timestamp from either the event data or the audio-visual data to navigate to the relevant portion of the other of the event data or the audio-visual data of point in time. For example, a user may wish to view, in the event grid, an event representing that a hatch has been opened on a tank (e.g., at a time 12:00:00AM). Using a timestamp (e.g., time data 304), the interface can locate audio-visual data that has a timestamp (e.g., time data 306) from the same point in time. The timestamp might not be the only criterion for locating audio-visual data. For example, audio-visual data can also be located based on the camera that recorded the audio-visual data.

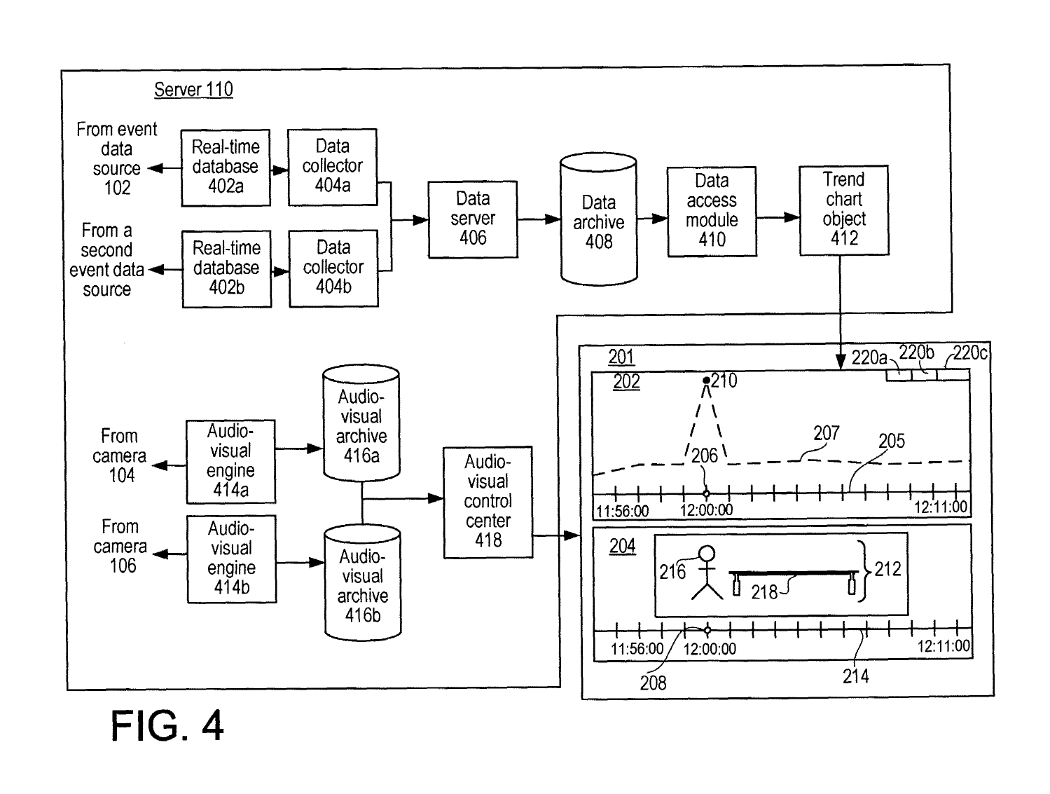

FIG. 4 is a more detailed exampled that shows how data is gathered from the data sources (e.g., cameras 104 and 106 and event data source 102) and processed to drive interface 201. The server 110 may have one or more networked “real time databases” 402a and 402b. The real time databases contain event data and time data of event data sources. The information stored within the real time databases can change over time based on the conditions being monitored by event data sources. Each real time database 402a and 402b may have one or more data collectors 404a and 404b that takes samples of pre-selected data stored in the real-time databases (e.g., event data and time data). The data server 406 can be a program that collects the data from the event data sources organizes the data into files (e.g., in formatted tables) and stores them in a data archive 408 as one or more files (FIG. 3).

The data access module 410 retrieves information from the data archive 408 (generally addressed by tag name and span of time desired), expands it (if necessary) and delivers the information to the requesting program (e.g., interface 201). Some data is saved in a compressed mode in order to save disk space. If a value remains substantially constant (e.g., within a selectable band where no change occurs) over time, then the initial value is written and a subsequent value is written when the value changes substantially. When the data files are retrieved, the software “expands” the two entries so that it looks to the receiving application like a multitude of samples were taken and stored.

Trend chart object 412 is an object (e.g., an ActiveX control) that can be placed into display software (e.g., interface 201). In some examples, the trend chart object 412 displays the event data retrieved from the data archive 408 as a set of one or more colored lines in a time-versus-value chart such as the trend chart 207 within the event grid 202.

Audio-visual engines 414a and 414b collect audio-visual data from cameras 104 and 106. The collected audio-visual data is stored in one or more files within one or more audio-visual archives 416a and 416b. As shown in FIG. 3, the stored files can contain both audio-visual data and time data. The audio-visual control center 418 controls playback of the audio-visual data (e.g., play, pause, rewind, forward) based on commands received from the user interface. The audio-visual control center 418 may act as the “central server” for the playback system. The audio-visual control center may be the central point of configuration, and may contain the software that drives the controls (e.g., ActiveX controls), the interface displayed in the browser, and other applications.

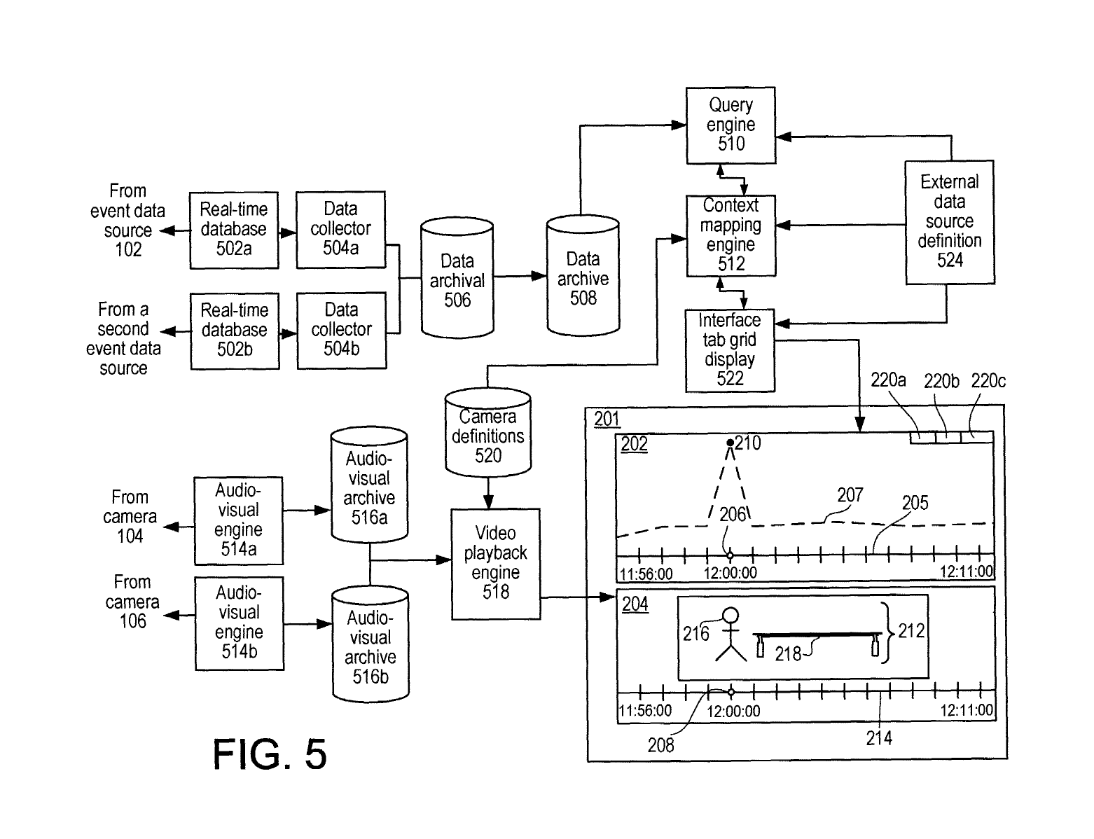

In the example of FIG. 5, one or more networked “real time databases” 502a and 502b may contain event data and time data received from the event data sources. The information stored within the real time databases can change over time based on the conditions being monitored by the event data sources. Each real time database 502a and 502b may have one or more data collectors 504a and 504b that takes samples of pre-selected data stored in the real-time databases (e.g., event data and time data). Audio-visual data is continuously collected by audio-visual engines 514a and 514b and stored into one or more files within one or more audio-visual archives 516a and 516b. Data archival element 506 can be a standard SQL database that can contain events, alarms, production values, quantities, statuses, batch records, manual actions identified by employee ID, or other data. The data within data archival element 506 may have a time stamp associated with the data. Data archive 508 is a centralized collection of multiple instances of 506 (e.g., a conglomeration of databases from a distributed system architecture). Query engine 510 is part of a video historian which accesses and queries the data archive 508 as requested/needed based on information provided from external data source definition 524. The external data source definition 524 provides describes which external tables to access, how to access them, and other functions.

In some examples, context mapping engine 512 takes the results of the query in 510, associates the information between the camera definitions in 520 and the external data sources definitions in 524 and adds camera/navigation context for that event record (e.g., it creates the record marking that causes interface tab grid display 522 to display a camera icon in the appropriate display record). Interface tab grid display 522 generates a user interface for the data based on column definitions and user preferences provided in external data sources definitions 524. The interface tab grid display 522 may also modify or extend the time stamp from the data archive 508 so that the video playback engine 518 will retrieve the correct stored video according to its timestamp.

A video playback engine 518 provides a means to control playback of the audio-visual data (e.g., play, pause, rewind, forward) based on parameters received from the interface 201. Exemplary parameters received from the interface that can be used to control playback of the audio-visual data include the selection of a specific camera and/or a time period. For example, a user may choose to view audio-visual data collected by camera 104 or camera 106 (or both) in the video window 204. A user may provide these parameters by selecting automatically generated clickable icons (not shown) that cause a change in playback when activated with a mouse cursor. The icons can appear within the interface as icons, radio buttons, or any other graphical representation that can be activated by user input.

In some examples, the clickable icons represent a list of cameras associated with a particular event record. For example, if the event of interest is a hatch being opened on a particular tank, a user may be able to select between a number of different cameras which may have recorded this event from different angles, distances, or resolutions.

A camera that records an event is referred to as being “mapped” to the event data that corresponds to that event. One way of mapping event data to a camera is to assign an event data source to one or more cameras. When the event data source provides an indication of an occurrence of an event, software “captures” the video clip from the associated camera or cameras. In some examples, one or more cameras can be mapped from text strings extracted from a database 508 and processed in 512 (e.g., the Process tab). For example, camera definitions 520 data can store attributes that are modifiable by a user (sometimes referred to as “extended data attributes”). These extended data attributes can be named by the user to associate a camera with a number of sources of event data (see FIG. 6, described below).

For example, a factory may contain a first conveyor belt (“CONVEYOR1”) for transporting bottles. A user may modify the extended data attributes associated with a camera (e.g., camera 104 in FIG. 1) so that a camera is associated with CONVEYOR1 (that is, audio-visual data generated by a camera will be associated with the data source CONVEYOR1). This association is stored in camera definitions 520. If the first conveyor belt stops, a sensor can generate event data in a format such as “CONVEYOR1_STOP” which is then passed by a query engine 510 to a context mapping engine 512 to determine whether any cameras are associated with the event data. Because the event data contains information that identifies the source of the event (CONVEYOR1), when the context mapping engine accesses the camera definitions 520 to determine whether any cameras are associated with CONVEYOR1, it will identify the camera that is mapped to the event data. A camera can be associated with more than one event data source, such as CONVEYOR1 and CONVEYOR2 and an event source can be mapped to multiple cameras, and vice-versa.

In some examples, the context mapping engine processes event data to determine which (if any) cameras are associated with the event data. If one or more cameras are associated with the event data, the interface 201 displays a list of camera identifiers as a clickable icon (not shown). As a result, a user can activate the icon (e.g., by clicking on the icon with a mouse cursor) to view audio-visual data collected from different cameras that are associated with the event data.

The context mapping engine performs the camera association by matching the list of extended data attributes (CONVEYOR1) against the appropriate column of data in the raw data set (for example, CONVEYOR1_STOP). The system does a partial string match from CONVEYOR1 to the Tagname (for example, CONVEYOR1_STOP would create a match with CONVEYOR1). If CONVEYOR1 is present in the raw data column, that camera is deemed to be associated with that event data. As a result, a new column is generated in the file (which may be called “camList”) that can identify one or more cameras that are associated with this the event data. For example, the camList column could be added as a third column to file 310 (FIG. 3).

FIG. 6 shows an exemplary interface 600 for modifying extended data attributes. The interface contains a list 610 of camera groups that include “Brew House” and “Packaging,” with camera Test being selected. In this example, the interface 600 runs in a browser 602 and contains a dialogue box 612. The dialogue box includes a field 604 in which a user can modify an extended data attribute for camera 1 (in this example, camera 1 is shown in a field 608, and has an IP address of 192.168.66.81 as shown in field 606). In this example, a user has entered CONVEYOR1 into the field 604 to associate the event data source CONVEYOR1 with camera 1. This yields a video batch tracking system that collects and associates video for batch processing, even when the equipment used by that batch processing is allocated at run-time.

In some examples, a user can create a new “tab” in the interface 201. A tab provides a way to bring in external data for correlation with the audio-visual data. The tabs allow a list of tabs to be extended, and provide a connection to an existing source of process data. The source of data is represented in the tabs (chart, grid, web page, etc.). The SDK tab allows for way to add new tabs AND to allow objects in those tabs to control the video window streaming. We implemented tabs that map data to video mapping for two types of data. Historical Trending Pen Charting and relational data tabular data but the system can be applied to any data source. For Pen Chart we allow the user to synchronize on time between data and video, we allow groups of cameras to be associated with groups of collected data tags to provide easier association. For SQL data we provide a means to associate one or more cameras to a row of user data. Typically, each row is an event or alarm that has a time embedded within the row. A “smart video tag” icon is displayed for the user to click as another column to navigate to the right camera and time frame.

The following is a list of exemplary tabs: HTML page, Trend Chart, Process Tab, Event List, and Production Report. In some examples, the HTML page displays information that is supplied via a user-specified HTML file or URL. The Trend Chart displays information relating to event data. The Process Tab displays the alarm (or other application) messages taken from a third-party system (such as a human-machine-interface or batch management system) that is mapped to one or more cameras. The Event List which is a list of detected and managed events, along with any associated video clips. The Production Report tab can have a report generator that contains user-defined and user-formatted information (e.g., in a form similar to a spreadsheet) as well as one or more video panels contained within the report that can be clicked and thus show the selected video at selected points in time.

In some examples, a tab can consist of a name and a javascript object to facilitate the display of data and calls into the video to synchronize the video with the data set being presented. For a tab that will access a foreign data set (SQL table or View, for example), a query service definition file is defined (e.g., an .INI file). The query service definition file may contain some or all of the following information: SQL Connection string, name of table or view to access, list of columns to use, alias names, and default order, column name of time stamp mapping, column name for camera association lookup, and name of camera extended field (in camera definitions 520) used for association matching.

In the diagram, the SQL connection string and query parameters are used to access the raw data set that exists in an external data source definition 524. The list of columns and aliases are provided to the interface for the grid display. The mapping fields are passed to the mapping engine to provide the video context to this record.

The interface 201 contains a custom set of tabs (e.g., tabs similar to 220a, 220b, and 220c). The tabs may be defined as a “tabGroup” (e.g., a list of tabs) and can be stored in an .xml file. An exemplary .xml file containing tab information is shown below.

```
<?xml version=“1.0” encoding=“utf-8” ?>
<root>
<tab>
      <title>Portal</title>
      <url>http://www.longwatch.com</url>
</tab>
<tab>
      <title>Alarms</title>
      <jsload>/GetGridJS.cgi</jsload>
      <params>{“service”:“Process”, “view”:
      “AlarmHistory”}</params>
</tab>
</root>
```

In the exemplary XML code above, after the standard XML heading line, the XML scheme includes an element called “root”. The root element contains two “tab” sub elements which begin and end with a <tab> element. In this example, the XML file generates two tabs with the titles “Portal” and “Alarm History.” The tab element can contain a number of different parameters, such as the exemplary parameters shown in table 1.

TABLE 1

| Element | |
|---|---|
| Name | Description |
| title | String to use as the tab title |
| url | Simple web html page to load within a tab. Either url or jsload is |
| | used. The default base path is located on the VCC server |
| | “ . . . Longwatch\User Data\CVE_ROOT”. Otherwise |
| | a user must specify a full url specification. |
| jsload | Contains a url to load a javascript file. This can either be a url |
| | to an EXT JS javascript file (http://extjs.com/) to load into the |
| | tab or Longwatch server cgi specification that will return a js |
| | file. |
| params | This element is used to pass parameters for the jsload url. This |
| | may include the format that begins with a ‘{’ and ends with |
| | a ‘}’. In the example, there are two url parameters for |
| | GetGridJS, |
| | service - Name of extension (folder name under |
| | “ . . . \Longwatch\User Data\CVE_ROOT\LUI\EventView\ |
| | Services” |
| | view - Name of query file to use to access |
| | the database located in the folder specified by service. |

In some examples, a database records an alarm history. The history is generated and stored into a table by an industrial control system (e.g., a Supervisory Control And Data Acquisition or “SCADA” system). Table 2 is an exemplary table that stores alarm history.

TABLE 2

| id | TimeDate | Tag | Description | Status | Priority |
|---|---|---|---|---|---|
| 1 | 5/8/2009 9:54:48 AM | FILLER1_IN | Area 1 - Input Flow 101 | HI | MED |
| 2 | 5/8/2009 9:54:53 AM | FILLER2_OUT | Area 2 - Output Flow 101 | HI | HI |
| 3 | 5/8/2009 9:54:58 AM | TEMP101 | Area 1 - Oven Temperature | LO | LO |
| 4 | 5/8/2009 9:55:03 AM | FILLER2_IN | Area 2 - Input Flow 101 | HI | MED |
| 5 | 5/8/2009 9:55:09 AM | FILLER2_OUT | Area 2 - Out Flow 101 | HI | MED |

In some examples, the above history of alarms is stored in a relational database and is available to be queried by standard programming tools. The database connector tab uses a GRID UI control to display this tabular data. In the above tab example the GetGridJS.CGI call generates a grid view of a relational database table. The params fields (Table 1) specify a specific named query. The combination of “service” and “view” map to a .QRY file that contains the needed connection information, column formatting, and data to video association mapping information. The result of a call to GetGridJS.cgi will be a visual display of the data in the database plus a new column representing that event's camera mapping (represented by a camera icon) as well as a “hot link” where clicking on the date/time value will automatically navigate to that selected time on the video without switching camera views. Thus, the data or camera view can be switched independently.

An interface (such as interface 201) can connect to a database containing a table (e.g., table 2) and can query the data contained within the table. Once the interface retrieves the queried data, the interface can display the data in the event grid 202. Various filtering, sorting, and paging capabilities can then be applied to data displayed in the event grid 202. The “Tag” and “TimeDate” columns within table 2 can be used to play back video based on a tag selected by a user (e.g., FILLER1_IN in table 2) and the time of the alarm (e.g., 5/8/2009 9:54:48 AM in table 8). The status and priority columns contain data that describes a state of the alarm and the priority of the event, respectively.

In order to implement a new tab within interface 201, the .xml file containing the tab data can be edited to contain new tab elements. For instance, an .xml file can be edited to contain the following data.

```
<tab>
      <title>MyAlarms</title>
      <jsload>/GetGridJS.cgi</jsload>
      <params>{“service”:“Process”, “view”:
      “AlarmHistory”}</params>
</tab>
```

This .xml file would create a new tab with the title “MyAlarms” and would use the query file “AlarmHistory” to access the database located in a specified folder. An INI text file can then be created called, for example, “AlarmHistory.qry” and can contain the following information.

[QueryService]

ConnectionString=“DSN=ProcessAlarms;”
From=“dbo.AlarmHistory”
PrimaryKey=“id”
DefaultSortBy=“TimeDate DESC”
DatesInUTC=false
TimeDateFieldName=“TimeDate”

The file above specifies a connection to the table dbo.AlarmHistory in the field “From”. The PrimaryKey field is a unique identifier for the row to allow support for paging. The DefaultSortBy field specifies the column to sort. DatesInUTC is a flag indicating if the stored timestamps are in UTC time zone or local time zone. With this information, a user can determine how to convert the timedate columns in a database to a local string. If the flag has a “true” value, dates are stored in GMT. If the flag has a “false” value, the dates are stored in local time zone. The TimeDateFieldName field indicates which column should be used as the primary time/date field for camera playback. Other fields such as ColMap can provide user definable column alias.

Query definition files (“.qry files”) can specify information needed by the external data source definition (e.g., external data source definition 524). The file can be a standard windows .INI file with sections and parameters in each section. One section is called “QueryService.” Other sections allow for the mapping of database column names to header names in the interface. These sections may be called “ColMap_xxx”, where xxx is the name of the database column name to be remapped. In some examples, the default header name in the grid is the name of the database column.

Table 3 represents a list of QueryService section definitions.

TABLE 3

| Name | Description | Possible Values |
|---|---|---|
| ConnectionString | ADO connection string | Some examples: |
| | to the database. This | “DSN=ProcessAlarms” |
| | string is database | “Provider=sqloledb;Data |
| | provider specific | Source=%COMPUTERNAME%\ |
| | | LONGWATCH;Initial |
| | | Catalog=Longwatch;User |
| | | ID=sa;Password=07161962” |
| From | Table name or View | Typical Examples: |
| | name that returns a SQL | dbo.AlarmHistory |
| | record set. | |
| PrimaryKey | Name of column used as | This field makes each row unique. It |
| | the primary key | is used during paging. |
| DefaultSortBy | When data is selected | Example: TimeDate DESC |
| | from the database this | |
| | field specifies the column | |
| | name and sort ORDER | |
| DatesInUTC | Used to define the time | true - will assume time is UTC and |
| | zone of the time and date | will convert to the local time of the |
| | field. The system will | VCC. |
| | always convert to local | false - assumes the time in the |
| | time. | database is local time. |
| TimeDateFieldName | Name of the database | |
| | column that identifies the | |
| | key time for starting of a | |
| | video playback. | |
| AssociationExtDataName | This is the name of the | Example: “Ext1” |
| | Longwatch Extended | Either “Ext(n)” where n = 1 . . . 5, or the |
| | Field used to associate a | the user defined name of the |
| | database field to a | extended field (see VCC config tab) |
| | camera. (See Camera | may be used |
| | association) | Example: “Equipment” |
| AssociationDBField | Name of one of the | Example: “Tag” |
| | database columns use to | |
| | perform camera | |
| | association. | |
| Columns | A comma separated | “id, TimeDate, Tag” |
| | string of database | |
| | columns to be shown in | |
| | the UI. Note: if this | |
| | column is not defined | |
| | than all of the columns | |
| | are shown. | |
| DefaultColWidth | Number of pixels used as | |
| | the default width for | |
| | columns if not specified | |
| | in a ColMap. | |

The AssociationDBField and AssociationExtDataName provide the means for the server to map individual rows into cameras. The AssociationDBField tells the system which column in the data set to match, and the AssociationExtDataName is the name of one of the extended data columns in the Longwatch camera database. When a row is processed, the server will take the data from the column named in the AssociatedDBField and try to “match” it to one or more cameras. The matching algorithm provides a way to group more than one camera to a specific event by specifying a list of strings separated by comma that represent the patterns to match against.

Custom user interfaces can also be created in a tab. For example, if a user wants to display data in a grid (e.g., event grid 202) with specific display options that are not included in the default template, an ExtJs javascript can be created and loaded into a tab. Examples of these javascripts include scripts that handle loading and interacting with a chart object as well scripts that access an alarm database and provides custom filtering.

In order to allow created javascript code to interact with the playback engine 518, the javascript code can access a global javascript object called “AppManager.” Table 4 below represents a list of AppManager definitions and functions.

TABLE 4

| Function | Description |
|---|---|
| AppManager.LinkTimeDate (Source) | This function is used to tell the |
| | playback system that an object wants |
| | to be in control of the playback time. |
| | This method can be called before |
| | making one or more calls to |
| | UpdateEventTime( ) (see below). The |
| | source parameter specified here is the |
| | same as the one passed to |
| | UpdateEventTime( ). In some |
| | examples, the source parameter is a |
| | simple string that uniquely identifies a |
| | plug-in. |
| AppManager.GetLinkTimeDate ( ) | Returns the current source of the time |
| | date changes. If the user is controlling |
| | the time date with the video controls |
| | (play mode) this will return “video”. |
| | The Trend chart returns “Trend”. |
| AppManager.ReleaseTimeDate (Source) | The system can be designed to have |
| | multiple potential “controller” of the |
| | global time of interest. LinkTimeDate |
| | and ReleaseTimeDate provide a means |
| | for the different controller to grab |
| | control of the global time date and |
| | change it. All others would then be |
| | slaves and respond to that controller's |
| | changes. Controllers are video slider, |
| | pen chart slider, event row select. |
| | These UI events grab the global time |
| | date and update it. |
| AppManager.UpdateEventTime (EventTime, Source) | This function is used to set the |
| | playback time of the currently selected |
| | cameras. The EventTime parameter is |
| | a Date object containing the time to |
| | seek to.The Source parameter is a |
| | string identifier of the source of the |
| | event. This parameter can be used to |
| | identify the originating source of the |
| | event. |
| AppManager.PlayVideo (EventTime, camList) | Seek the video to the EventTime for |
| | the list of cameras specified in |
| | camList. CamList may have the |
| | following format. |
| | UnitName:Cam#,UnitName:Cam# |
| | Example: “LVE1:0,LVE2:1” means |
| | playback camera 0 on LVE1 and |
| | camera 1 on LVE2. Note: when a |
| | camera association column is |
| | generated for a row of a data set the |
| | value of the column is in the camList. |
| AppManager.getCurrentAccessMode( ) | Returns the current access mode of the |
| | video system. |
| TabManager.Register (obj) | This function can be used to register |
| Called with the access mode changes (0-Guard, 1-Live, | with the system an object that will be |
| 2-DVR, 3-Event) | called when the user changes |
| this.loadChart = function (chartName) | something in the user interface. This |
| Called when a trend chart is loaded (could be on a | is used to cause a tab to respond to |
| View load) | playback time or access mode changes. |
| | The “obj” that is passed is assumed to |
| | be a javascript object with the |
| | following functions: |
| | this.UpdateEventTime = |
| | function(EventTime, Source) |
| | Called with the PlayBack time |
| | changes, Source is a string identifier of |
| | the component that initiated the |
| | change. |
| | this.NextEvent = function(acMode) |
| | Passes in the current access mode |
| | when called |
| | this.PrevEvent = function(acMode) |
| | Passing in the current access mode |
| | when called |
| | this.setAccessMode=function(acMode) |

FIG. 7 is an exemplary screenshot 700 of the interface 201. Trend chart 702 is located in the upper region of the screenshot, and three video clips 704a-c are being shown in the video window 706 located at the bottom of the screenshot. A time cursor 708 has selected a time 4:46:19 to display the actual trend values (32.04 and −8.38 respectively for the two graph lines 712 and 714). The video window 706 is playing back three video clips that begin at time 16:46:19 for “Cam2,” “Camera4” and “Camera5” respectively. Camera selection window 710 allows a user to select which video clips to display in video window 706. In this example, video is being displayed that is associated with the cameras Cam2, Camera4, and Camera 5.

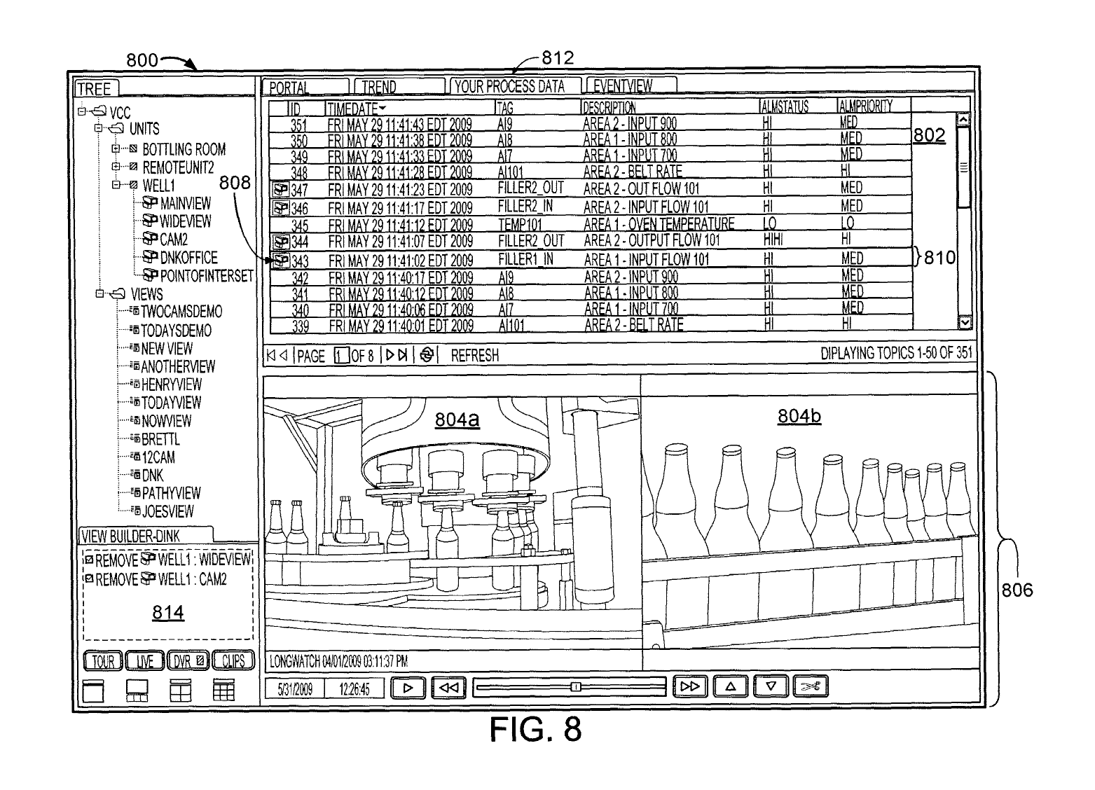

FIG. 8 is also an exemplary screenshot 800 of the interface 201. In this example, the Process Tab 812 is selected. With the Process Tab selected, the interface 201 shows process data in a process data window 802. The process data is contained in process messages (e.g., process message 810), and could be data that was extracted from one or more external databases. The messages can then be parsed and mapped to one or more cameras. If a message has been mapped to a camera (e.g., if a “relationship” exists between a message and a camera), a camera icon 808 can be displayed near the message 810. Clicking on a message (e.g., with a cursor controlled by a mouse) that has an associated camera icon will cause the interface to display video clips (e.g., video clips 804a and 804b) in a video window 806 from the associated camera(s) at a time contained within the message. Camera selection window 814 allows a user to select which video clips to display in video window 806. In this example, video is being displayed that is associated with the cameras “Cam2,” and “WideView.”

Other implementations are within the scope of the following claims.

For example, A wide variety of other implementations are possible, using dedicated or general purpose hardware, software, firmware, and combinations of them, public domain or proprietary operating systems and software platforms, and public domain or proprietary network and communication facilities.

A wide variety of audio-visual capture devices may be used, not limited to video devices. For example, cameras that capture still photographs could be used, as well as microphones that capture audio data.

The remote location and the central location need not be in separate buildings; the terms remote and central are meant to apply broadly to any two locations that are connected, for example, by a low bandwidth communication network.

User interfaces of all types may be used as well, including interfaces on desktop, laptop, notebook, and handheld platforms, among others. The system may be directly integrated into other proprietary or public domain control, monitoring, and reporting systems, including, for example, the Intellution-brand or Wonderware brand or other human machine interface using available drivers and PLC protocols.

1. A method comprising
at a user interface that portrays both (a) at least a portion of a time history of a sequence of events that has occurred and (b) at least a portion of a time track of audio-visual material associated with the time history of the sequence of events,
receiving an indication of one of the events or of a time, and
causing the portrayal of either the time history or the time track to be adjusted to be in synchrony with the other of the time history or the time track with respect to which the indication has been received.

2. The method of claim 1 in which the audio-visual material comprises at least one of video material and audio material.

3. The method of claim 1 in which the audio-visual material and the time history are stored separately.

4. The method of claim 3 in which storage of the audio-visual material and the time history of the sequence of events remains separate while the portrayal is caused to be in synchrony.

5. The method of claim 1 also comprising enabling a user to select a type of the events, the sequence of which is portrayed graphically.

6. The method of claim 1 also comprising enabling a user to navigate within the interface with respect to time.

7. The method of claim 1 also comprising enabling a user to navigate within the interface with respect to information related to the sequence of events.

8. The method of claim 1 also comprising associating an audio-visual capture device with a context in which the sequence of events occurs.

9. The method of claim 8 in which the audio-visual capture device comprises a camera.

10. The method of claim 8 in which the associating comprises comparing context information with configurable parameters.

11. The method of claim 10 in which the associating comprises generating a record that contains an association between the audio-visual capture device and the context in which the sequence of events occurs.

12. The method of claim 1 further comprising
storing in a first file the time history, the first file comprising one or more event timestamps representative of times of occurrence of the events, and
storing in a second file the audio-visual material, the second file comprising one or more audio-visual timestamps representative of points in time within the audio-visual material.

13. The method of claim 12 in which the user interface displays a first timeline associated with the audio-visual material and a second timeline associated with the time history, the first and second timelines being based in part on the event timestamps and the audio-visual timestamps.

14. The method of claim 13 in which navigating to a specific point in time within either the first timeline or the second timeline causes a navigation to the specific point in time within the other of the first timeline or the second timeline.

15. A method comprising
as a user navigates along (a) a graphically displayed time history of a sequence of events that has occurred or (b) a simultaneously graphically displayed time track of audio-visual material associated with the time history of the sequence of events,
automatically synchronizing the display of the other of the time history or the time track.

16. A method performed in a computer system comprising
receiving audio-visual material and storing the audio-visual material in a first storage location,
receiving time history of a sequence of events and storing the time history in a second storage location, and
allowing an application to access the audio-visual material and the time history in order to simultaneously display a graphically displayed time history of a sequence of events that has occurred and a time track of audio-visual material associated with the time history of the sequence of events.

17. A method comprising
at a user interface: (a) portraying to a user audio-visual material for a frame of view being monitored, and (b) displaying navigation features to the user that are based on data about occurrences in the frame of view,
the navigation features being based on existing data that has been accumulated by a system that controls at least some of the occurrences in the frame of view,
the navigation features enabling the user to identify one of the occurrences as an occurrence of interest and to have the user interface then automatically portray a portion of the audio-visual material that relates to that occurrence of interest.

18. The method of claim 17 in which the data about occurrences associated with the field of view comprises a trend chart.

19. The method of claim 17 in which the data about occurrences associated with the field of view comprises process events or alarms.

20. The method of claim 17 in which the data about occurrences associated with the field of view comprises data fields of a process control database.

21. The method of claim 17 in which the system comprises a process control system and the frame of view and the occurrences are associated with a process being controlled.

22. A method comprising
at a user interface: (a) portraying to a user audio-visual material for a frame of view being monitored, and (b) displaying navigation features to the user that are based on messages about occurrences in the frame of view,
the navigation features being based on existing data that has been accumulated by a system that controls at least some of the occurrences in the frame of view,
the navigation features enabling the user to identify at least one of the messages as a message of interest and to have the user interface then automatically portray a portion of the audio-visual material that relates to the one or more messages.
